(19) United States
(12) Patent Application Publication
(10) Pub. No.: US 2010/0159259 A1
(43) Pub. Date: Jun. 24, 2010

(54) VOLTAGE SWITCHABLE DIELECTRIC MATERIAL INCORPORATING P AND N TYPE MATERIAL

(76) Inventors: Lex Kosowsky, San Jose, CA (US); Robert Fleming, San Jose, CA (US); Ning Shi, San Jose, CA (US); Junjun Wu, Woodbury, MN (US)

Correspondence Address: MAHAMEDI PARADICE KREISMAN LLP, 550 Winchester Boulevard, Suite 605, SAN JOSE, CA, 95128, US

(21) Appl. No.: 12/642,799

(22) Filed: Dec. 19, 2009

Related U.S. Application Data
(60) Provisional application No. 61/139,512, filed on Dec. 19, 2008.

(51) Int. Cl. B32B 15/04; B32B 9/04; H01B 1/00; H01B 1/04

(52) U.S. Cl. 428/457; 428/411.1; 252/500

(57) ABSTRACT

A composition of VSD material comprises a binder, and one or more types of particles that include a concentration of doped semiconductor particles.

### RELATED APPLICATIONS

This application claims benefit of priority to Provisional U.S. Patent Application No. 61/139,512, entitled VOLTAGE SWITCHABLE DIELECTRIC MATERIAL INCORPORATING INTRINSICALLY N AND P DOPED SILICON NANOPARTICLES, filed Dec. 19, 2008; the aforementioned priority application being hereby incorporated by reference in its entirety.

### TECHNICAL FIELD

Embodiments described herein pertain generally to voltage switchable dielectric material, and more specifically to voltage switchable dielectric composite materials containing P and N type material.

### BACKGROUND

FIG. 7 is an energy diagram for a PN junction. Generally, P type particles and N type particles (e.g. doped silicon) have high carrier mobility. Both P and N type particles, when used individually, are conductive with application of an electric field. However, when P and N type particles are combined (“P N junction”), an energy barrier is formed at their junction. When the P N junction is at an equilibrium state where no external electric field is present, there is no net current flow. While some drift and diffusion occurs in the so-called depleted region, an energy barrier must be overcome in order to cause electrons to cross over the barrier (i.e. flow from the N type particle to the P type particle). In general, current flow results in the movement of electrons (from N to P) and holes (from P to N).

For reference, in figures depicted, Ec is the conduction band, Ef is the device fermi energy level, Ei is the intrinsic Fermi level of the undoped semiconductor, and Ev is the valence band.

The energy barrier may be manipulated to increase or decrease the amount of energy needed to cause net electron flow. When the applied voltage is positive in P type and negative in N type, the effect is to create a forward bias, as depicted in FIG. 8A and FIG. 8B. The forward bias reduces the energy barrier across the PN junctions at which point current is formed. In the other case, if the voltage is negative in P side and positive in N side (refer as reverse bias as in FIG. 9A and FIG. 9B), the energy barrier will increase due to the direction (or polarity) of the applied voltage. FIG. 10 shows a current voltage diagram for PN junctions, as understood in the art.

### BRIEF DESCRIPTION OF THE DRAWINGS

FIG. 1 is an illustrative (not to scale) sectional view of a layer or thickness of VSD material, depicting the constituents of VSD material in accordance with various embodiments.

FIG. 2 illustrates a composition of VSD material that includes P or N type doped semiconductor particles, under an embodiment.

FIG. 3 illustrates an embodiment for using both P type and N type doped semiconductor particles that are distributed into a polymer binder, according to an embodiment.

FIG. 4A illustrates an embodiment in which a layered quantity of doped semiconductor particles is combined with a layer of VSD material, according to another embodiment.

FIG. 4B illustrates an embodiment in which a P type and an N type semiconductor layer form a combined thickness with protective voltage switchable characteristics.

FIG. 5A illustrates a substrate device that is configured with VSD material having a composition such as described with any of the embodiments provided herein.

FIG. 5B illustrates a configuration in which a conductive layer is embedded in a substrate.

FIG. 5C illustrates a vertical switching arrangement for incorporating VSD material into a substrate.

FIG. 6 is a simplified diagram of an electronic device on which VSD material in accordance with embodiments described herein may be provided.

FIG. 7 is an energy diagram for a PN junction, under the prior art.

FIG. 8A illustrates an energy diagram for PN junction at forward bias, depicted as prior art.

FIG. 8B is an electron flow diagram of the PN junction at forward bias, depicted as prior art.

FIG. 9A illustrates an energy diagram for PN junction at reversed bias, depicted as prior art.

FIG. 9B is an electron flow diagram for PN junction at reversed bias, depicted as prior art.

FIG. 10 shows a current voltage diagram for PN junctions, as understood in the art.

### DETAILED DESCRIPTION

According to some embodiments, a composition of VSD material comprises a binder, and one or more types of particles that include a concentration of doped semiconductor particles.

Still further, some embodiments include VSD material that has a material that includes a P type characteristic and material that has an N type characteristic.

In another embodiment, a substrate device includes a pair of electrodes separated by a thickness of material that (i) includes voltage switchable dielectric (VSD) material, and (ii) a concentration of at least one of P type or N type material. The VSD material may be separated from another layer that includes the P and/or N type material. Alternatively, the VSD layer includes the P and/or N type material as integrated and mixed components.

Additionally, some embodiments include a substrate device that includes a thickness comprising a first layer of P type material, and a second layer of N type material. The thickness, including the P type material and the N type material, span a majority of the substrate device. The layers of P and N type material combine to form a PN layer that is triggerable to conduct at some characteristic voltage, akin to a layer of VSD material.

As used herein, the term “P type”, in the context of material, means material that has more holes than electrons. The term “N type” in the context of material means material that has more electrons than holes.

### OVERVIEW OF VSD MATERIAL

As used herein, “voltage switchable material” or “VSD material” is any composition, or combination of compositions, that has a characteristic of being dielectric or non-conductive, unless a field or voltage is applied to the material that exceeds a characteristic level of the material, in which case the material becomes conductive. Thus, VSD material is a dielectric unless voltage (or field) exceeding the characteristic level (e.g. such as provided by ESD events) is applied to the material, in which case the VSD material is switched into a conductive state. VSD material can further be characterized as a nonlinear resistance material. With an embodiment such as described, the characteristic voltage may range in values that exceed the operational voltage levels of the circuit or device several times over. Such voltage levels may be of the order of transient conditions, such as produced by electrostatic discharge, although embodiments may include use of planned electrical events. Voltage and currents from ESD events can be very high, damaging standard transistor junctions. Furthermore, one or more embodiments provide that in the absence of the voltage exceeding the characteristic voltage, the material behaves similar to the binder.

Still further, an embodiment provides that VSD material may be characterized as material comprising a binder mixed in part with conductor or semi-conductor particles. In the absence of voltage exceeding a characteristic voltage level, the material as a whole adapts the dielectric characteristic of the binder. With application of voltage exceeding the characteristic level, the material as a whole adapts conductive characteristics.

Many compositions of VSD material provide desired ‘voltage switchable’ electrical characteristics by dispersing a quantity of conductive materials in a polymer matrix to just below the percolation threshold, where the percolation threshold is defined statistically as the threshold by which a continuous conduction path is likely formed across a thickness of the material. Other materials, such as insulators or semiconductors, may be dispersed in the matrix to better control the percolation threshold. Still further, other compositions of VSD material, including some that include particle constituents such as core shell particles (as described herein) or other particles may load the particle constituency above the percolation threshold. As described by embodiments, the VSD material may be situated on an electrical device in order to protect a circuit or electrical component of device (or specific sub-region of the device) from electrical events, such as ESD or EOS. Accordingly, one or more embodiments provide that VSD material has a characteristic voltage level that exceeds that of an operating circuit or component of the device.

According to embodiments described herein, the constituents of VSD material may be uniformly mixed into a binder or polymer matrix. In one embodiment, the mixture is dispersed at nanoscale, meaning the particles that comprise the organic conductive/semi-conductive material are nano-scale in at least one dimension (e.g. cross-section) and a substantial number of the particles that comprise the overall dispersed quantity in the volume are individually separated (so as to not be agglomerated or compacted together).

Still further, an electronic device may be provided with VSD material in accordance with any of the embodiments described herein. Such electrical devices may include substrate devices, such as printed circuit boards, semiconductor packages, discrete devices, Light Emitting Diodes (LEDs), and radio-frequency (RF) components.

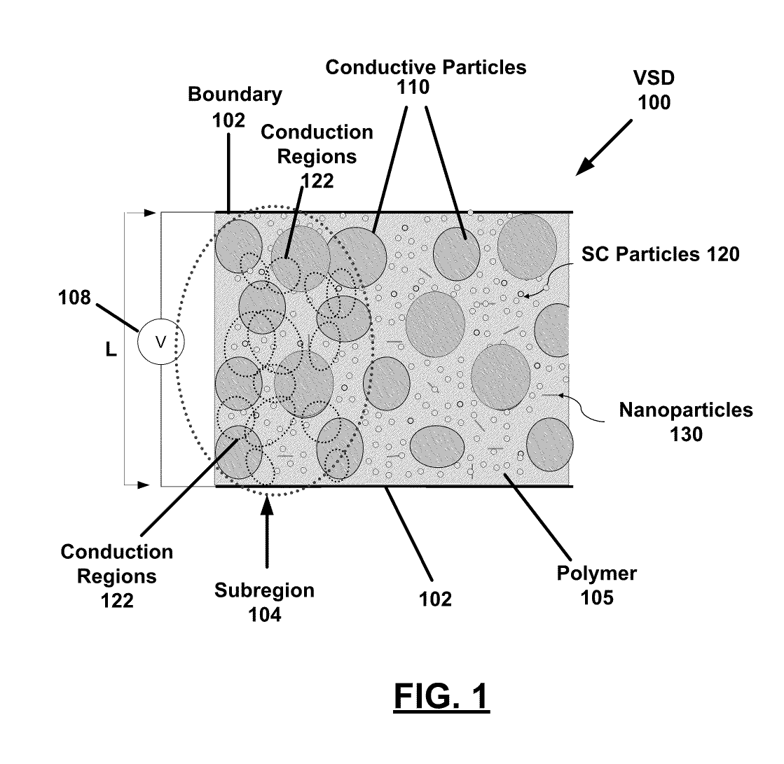

FIG. 1 is an illustrative (not to scale) sectional view of a layer or thickness of VSD material, depicting the constituents of VSD material in accordance with various embodiments. As depicted, VSD material 100 includes matrix binder 105 and various types of particle constituents, dispersed in the binder in various concentrations. The particle constituents of the VSD material may include a combination of conductive particles 110, semiconductor particles 120, and/or nano-dimensioned particles 130. According to some embodiments, the semiconductor particles 120 are (or at least include) doped semiconductors, such as doped silicon particles. In one embodiment, the conductive particles 110 form a constituency of micron dimensioned particles. The doped semiconductor particles 120 may be nano-dimensioned or micron-dimensioned. Organic or organometallic molecultes, polymers, or compounds with preferential N or P character may be dispersed, dissolved, or reacted into the binder. As an addition or alternative, varistor particles (individual particles with non-linear resistive characteristics) may also be included in the composition of VSD material.

As an alternative or variation, the VSD composition may omit the use of conductive particles 110 or nano-dimensioned particles 130, particularly with the presence of the concentration of doped semiconductor particles 120 being at, or exceeding the percolation threshold. Moreover, more than one type of semiconductor particles 120 may be used, and in varying concentration levels, depending on electrical/physical characteristics desired from the VSD material. Thus, the type of particle constituent that are included in the VSD composition may vary, depending on the desired electrical and physical characteristics of the VSD material. Specific examples for the type of doped semiconductor particles 120 that can be used in various embodiments are listed and described in greater detail below.

Examples for matrix binder 105 include polyethylenes, silicones, acrylates, polymides, polyurethanes, epoxies, polyamides, polycarbonates, polysulfones, polyketones, and copolymers, and/or blends thereof. Other examples of material for forming binder 105 are provided below.

Examples of conductive materials 110 include metals such as copper, aluminum, nickel, silver, gold, titanium, stainless steel, nickel phosphorus, niobium, tungsten, chrome, other metal alloys, or conductive ceramics like titanium diboride or titanium nitride. While the semiconductor particles 120 may include doped semiconductors, non-doped semiconductors may also be incorporated as particle constituents of VSD. In particular, the composition of VSD may include semiconductor constituents that include both organic and inorganic semiconductors. Some inorganic semiconductors include, silicon carbide, Boron-nitride, aluminum nitride, nickel oxide, zinc oxide, zinc sulfide, bismuth oxide, titanium dioxide, cerium oxide, bismuth oxide, in oxide, indium in oxide, antimony in oxide, and iron oxide, praseodynium oxide. The specific formulation and composition may be selected for mechanical and electrical properties that best suit the particular application of the VSD material.

According to some embodiments, one or more types of nano-dimensioned particles 130 are used. Depending on the implementation, at least one constituent that comprises a portion of the nano-dimensioned particles 130 are (i) organic particles (e.g. carbon nanotubes, graphenes); or (ii) inorganic particles (metallic, metal oxide, nanorods, or nanowires). The nano-dimensioned particles may have high-aspect ratios (HAR), so as to have aspect ratios that exceed at least 10:1 (and may exceed 1000:1 or more). The particle constituents may be uniformly dispersed in the polymer matrix or binder at various concentrations. Specific examples of such particles include copper, nickel, gold, silver, cobalt, zinc oxide, in oxide, silicon carbide, gallium arsenide, aluminum oxide, aluminum nitride, titanium dioxide, antimony, Boron-nitride, in oxide, indium in oxide, indium zinc oxide, bismuth oxide, cerium oxide, and antimony zinc oxide.

The dispersion of the various classes of particles in the matrix 105 may be such that the VSD material 100 is non-layered and uniform in its composition, while exhibiting electrical characteristics of voltage switchable dielectric material. Generally, the characteristic voltage of VSD material is measured at volts/length (e.g. per 5 mil), although other field measurements may be used as an alternative to voltage. Accordingly, a voltage 108 applied across the boundaries 102 of the VSD material layer may switch the VSD material 100 into a conductive state if the voltage exceeds the characteristic voltage for the gap distance L.

As depicted by a sub-region 104 (which is intended to be representative of the VSD material 100), VSD material 100 comprises particle constituents that individually carry charge when voltage or field acts on the VSD composition. If the field/voltage is above the trigger threshold, sufficient charge is carried by at least some types of particles to switch at least a portion of the composition 100 into a conductive state. More specifically, as shown for representative sub-region 104, individual particles (of types such as conductor particles (if used) and doped semiconductor particles) acquire conduction regions 122 in the polymer binder 105 when a voltage or field is present. The voltage or field level at which the conduction regions 122 are sufficient in magnitude and quantity to result in current passing through a thickness of the VSD material 100 (e.g. between boundaries 102) coincides with the characteristic trigger voltage of the composition. FIG. 1 illustrates presence of conduction regions 122 in a portion of the overall thickness. The portion or thickness of the VSD material 100 provided between the boundaries 102 may be representative of the separation between lateral or vertically displaced electrodes. When voltage is present, some or all of the portion of VSD material can be affected to increase the magnitude or count of the conduction regions in that region. When voltage is applied, the presence of conduction regions may vary across the thickness (either vertical or lateral thickness) of the VSD composition, depending on, for example, the location and magnitude of the voltage of the event. For example, only a portion of the VSD material may pulse, depending on voltage and power levels of the electrical event.

Accordingly, FIG. 1 illustrates that the electrical characteristics of the VSD composition, such as conductivity or trigger voltage, may be affected in part by (i) the concentration of particles, such as doped semiconductive particles, conductive particles, nanoparticles (e.g. HAR particles), or other particles (e.g. varistor particles, and/or core shell particles); (ii) electrical and physical characteristics of the particles, including resistive characteristics (which are affected by the type of particles, such as whether the particles are core shelled or conductors); and (iii) electrical characteristics of the polymer or binder.

Specific compositions and techniques by which organic and/or HAR particles are incorporated into the composition of VSD material is described in U.S. patent application Ser. No. 11/829,946, entitled VOLTAGE SWITCHABLE DIELECTRIC MATERIAL HAVING CONDUCTIVE OR SEMI-CONDUCTIVE ORGANIC MATERIAL; and U.S. patent application Ser. No. 11/829,948, entitled VOLTAGE SWITCHABLE DIELECTRIC MATERIAL HAVING HIGH ASPECT RATIO PARTICLES; both of the aforementioned patent applications are incorporated by reference in their respective entirety by this application.

Under some conventional approaches, the composition of VSD material has included metal or conductive particles that are dispersed in the binder of the VSD material. The metal particles may range in size and quantity, depending in some cases on desired electrical characteristics for the VSD material. In particular, metal particles may be selected to have characteristics that affect a particular electrical characteristic. For example, to obtain lower clamp value (e.g. an amount of applied voltage required to enable VSD material to be conductive), the composition of VSD material may include a relatively higher volume fraction of metal particles. As a result, it becomes difficult to maintain a low initial leakage current (or high resistance) at low biases due to the formation of conductive paths (shorting) by the metal particles.

Doped Semiconductor Particle Constituents of VSD Material

The inclusion of doped semi-conductors in VSD material can enable the formation of particle-sized electric field barriers that are akin to the formation of PN junctions within the polymer matrix. The electric field barriers are stable when no voltage is present. However, embodiments recognize that the presence of such electric field barriers may be manipulated to increase or decrease the amount of energy needed to cause net electron flow within the binder. In instances when the doped semiconductor particles form electric field barriers that are positive to P type and negative to N type, a forward bias is created that reduces the energy barrier across the ‘junctions’ of the P type and N type material, at which point current is formed. In the other case, if the voltage is negative in P side and positive in N side, the energy barrier will increase due to the direction (or polarity) of the applied voltage.

With reference to FIG. 1, the semiconductor particles 120 may include or correspond to P type particles and/or N type particles. According to some embodiments, only one of P type or N type doped semiconductor particles are included in the concentration. More particularly, the concentration of doped semiconductor particles 120 includes P type particles, dispersed in the polymer binder 105. The polymer binder 105 may serve as an N type medium, so that the presence of the P type particles in the polymer binder 105 results in the formation of individual energy barriers.

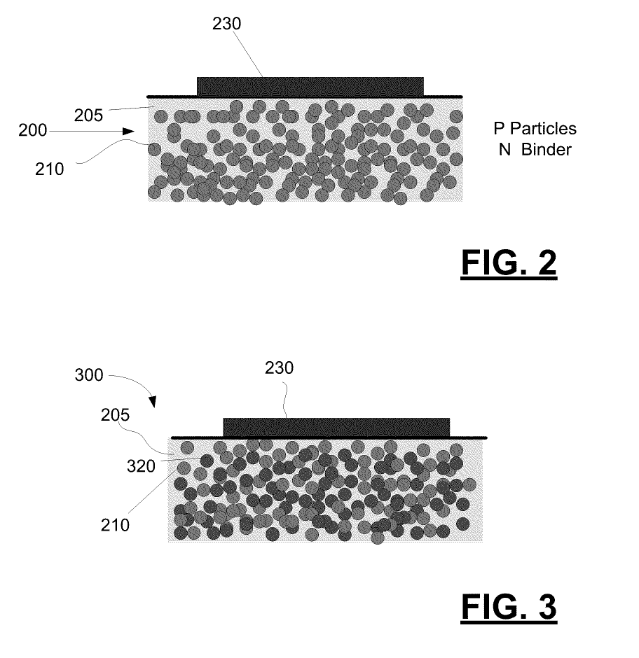

FIG. 2 illustrates a composition of VSD material that includes P (or N) type doped semiconductor particles, under an embodiment. As shown, P type doped semiconductor particles 210 are loaded into the polymer binder 205 to or past the point of percolation (e.g. 40% by volume). With sufficient voltage or electric field present, the electric barrier formed by the P type semiconductor particles dispersed in the binder is reduced, promoting current flow. The result is the composition of VSD material 200 is switched into the conductive state with application of voltage that exceeds some characteristic value that is determined, at least in part, on the electrical barrier between the P type particles and the polymer binder.

As shown by an embodiment of FIG. 2, the VSD material 200 is dispersed as a layer that is in physical or electrical (when the material is switched) with an electrode 230. In one implementation, VSD material 200 is sandwiched between a pair of electrodes, so as to form a vertical switching arrangement. In a configuration shown by FIG. 2, the layer of VSD composition can comprise additional types of particles, such as HAR nanoparticles or conductors. More specifically, such additional types of particles may be added to the composition to achieve desired electrical characteristics, in relation to a thickness of the layer of VSD material.

FIG. 3 illustrates an embodiment for using both P type and N type doped semiconductor particles that are distributed into a polymer binder, according to an embodiment. More specifically, VSD composition 300 is comprised of a concentration of P type doped semiconductor particles 210 and N type doped semiconductor particles 320, loaded into a polymer binder 205. As with an embodiment of FIG. 2, other types of particles, such as HAR particles and/or metal particles, can be present in the composition, depending on desired electrical characteristics and thickness of the VSD material 300. With sufficient voltage or electric field presence, the P and N type particles combine to form ‘effective PN junctions’. With presence of electric field at the electrode 230, the electrical barrier of at least a portion of the ‘effective PN junctions’ is reduced to promote current flow within the thickness of the composition. Thus, the composition 300 can be switched into the conductive state with application of voltage that exceeds a characteristic value that is determined, at least in part, on the voltage or field value required to overcome the electrical barrier formed by the P and N type particles in the polymer binder 205.

With further reference to FIG. 3, to enhance the formation of ‘PN junctions’ in the composition, more N type semiconductor particles 320 may be used than P type semiconductor particles 210. For example, the concentration of N type particles may be greater than the concentration of P type particles by at least 50%. As additional examples, a ratio of 2:1 or 3:1 may be used for N:P type particles to increase the formation of PN junctions in the binder 205.

While numerous types of doped semiconductor particles can be used to formulate VSD material (or doped semiconductor layers, as described with other embodiments), specific examples include doped silicon, germanium, or compound semiconductors, such as gallium nitride, gallium arsenide, indium arsenide, and other compound semiconductors (e.g. of Type III-V).

With further reference to FIG. 2 and FIG. 3, polymer binder 205 may be formulated from undoped or untreated polymer, such as Epon 828. As an alternative to addition to embodiments described, the binder 205 can be pre-treated or formulated to have a general N or P type characteristic. According to some embodiments, the polymer 205 is molecularly composed of material that is either N or P type, using, for example, solvent soluble P or N type materials that bond with polymer molecules. Alternatively, the binder 205 may include N or P type material that are dispersed as particles within the binder 205. In one embodiment, the binder 205 includes N or P type semiconductor material that is organic or organometallic. Such material can also be small molecule or polymeric. Examples of P type organic or organometallic semiconductor material for inclusion in the binder 205 include pentacene, rubrene, copper phthalocyanine, α-sexithiophene, polythiophene, and regioregular poly(3-hexylthiophene). Examples of N type organic or organometallic semiconductor material for inclusion in the binder 205 include naphthalene carbodiimide derivatives such as N,N′-bis-n-butyl-1,4,5,8-naphthalenediimide, and perylene derivatives such as N,N′-bis-(1-pentyl)hexyl-3,4,9,10-perylene diimide, perfluorinated metallophthalocyanines, perfluorinated pentacenes, and C60 fullerenes.

Numerous combinations for combining doped semiconductor particles and binder 205 are possible, and include (i) P type doped semiconductor particles mixed in binder 205 having N type characteristic; (ii) both P and N type doped semiconductor particles mixed in binder 205; (iii) both P and N type doped semiconductor particles mixed in binder 205 having N or P type characteristic; or (iv) N type doped semiconductor particles mixed in binder 205 having P type characteristic. When both P and N type particles are present, the respective concentration levels of each kind of doped semiconductor particle may vary and be unequal, depending on desired characteristics of the VSD material, as well as the presence and kind of other constituents of the composition. In a variation, organic or organometallic semiconductor material may also substitute for doped semiconductor particles. In either case, embodiments provide for use of particle and/or binder combinations that have P and N type characteristics, to promote ‘PN junction’ behavior or characteristics within the VSD composition. The combination of N or P type binder 205, and N and/or P type semiconductor particles enables VSD formulations that can promote current flow by reducing the barrier of the ‘effective PN junction’ formed by the combination.

With reference to FIG. 2 and FIG. 3, the use of P (or N) type semiconductor particles in the polymer binder, with or without N (or P) type semiconductor particles, enable the overall particle concentration of the composition of VSD material to extend past percolation. Moreover, the use of doped semiconductor particles enables the characteristic properties of the VSD composition to be tuned to those of the semiconductor particles. In particular, the characteristic voltage or field by which the VSD composition switches into a conductive state is directly impacted by the values needed to trigger the avalanche effect in the doped semiconductor particle constituents.

Process Formulation Examples

A composition of VSD material may be formulated using doped active elements, under an embodiment. In one implementation, a gas capable of being used in a chemical vapor deposition (CVD) process to form polysilicon (e.g., silane gas, dichlorosilane gas) is introduced into a vapor phase process reactor (e.g., an atmospheric-pressure CVD reactor, a reduced pressure CVD reactor, or a plasma-enhanced CVD reactor), along with gasses capable of providing N dopant and P dopant species (e.g. phosphine or arsine, capable of providing N dopants phosphorus or arsenic, respectively; and diborane, capable of providing P dopant boron) to the formed polysilicon material. When operated in a conventional manner, the process performed in the vapor phase process reactor results in the formation of small particles of silicon that are N doped, P doped, or doped with substantially equal concentrations of N dopants and P dopants. The particles generally have sizes smaller than 1 micron in diameter, and can be nano-dimensioned. After the formation process, the particles may be collected and removed from the process reactor in bulk. The particles may be added to a VSD formulation, then mixed to create the VSD material. Semiconductor particles may alternatively be synthesized via a solution phase process.

Silicon (20 nm) from Nanogram, 20% by wt in NMP may be selected as a semiconductor constituent. 1.92 g of carbon nanotubes are mixed with 97.9 g of epoxy and 220 g of solvent. After mixture, a premixed composition of VSD material is formed. Additional mixing may be performed. In one formulation, the resulting VSD exhibited the following characteristics.

| | Electrical Properties | | |
|---|---|---|---|
| | Median | Median | Median Post |
| | Trigger (V) | Clamp (V) | TLP (V) |
| 3 mil gap | 499 | 234 | 8.E−11 |

As another example, the silicon nanoparticles are treated with aminopropyl triethoxysilane (A-1100) molecule. 0.3% by wt of A-1100 is added to the Si nanoparticles and dry mixed. The above experiment was repeated by replacing the silicon particles with the A-1100 treated Si particles.

| | Electrical Properties | | |
|---|---|---|---|
| | Median | Median | Median Post |
| | Trigger (V) | Clamp (V) | TLP (A) |
| 3 mil gap | 487 | 232 | 2.E−11 |

Alternatively, the process may be performed to deposit one or more layers of silicon nanoparticles upon the surface of substrate materials placed in the reactor beforehand, the substrate materials being intended to receive such a deposition. The bulk nanoparticles, or the substrates with deposited layers of nanoparticles, are next sintered at a high temperature, which causes the nanoparticles to group together into clusters of nanoparticles, the clusters achieving sizes generally greater than a micron and ranging up to many microns in diameter. Depending on the vapor phase processing conditions—including the vapor-phase reaction temperature, the total flow of reactant gases, and the relative amounts of reactant gases (for example, the relative amounts of silane, diborane, and phosphine), and the sintering conditions—including time and temperature—there will result clusters of primarily P doped polysilicon nanoparticles, clusters of primarily N doped polysilicon nanoparticles, and/or clusters of polysilicon with substantially equal numbers of P doped and N doped polysilicon nanoparticles.

Usage of Layered Doped Semiconductor Particles

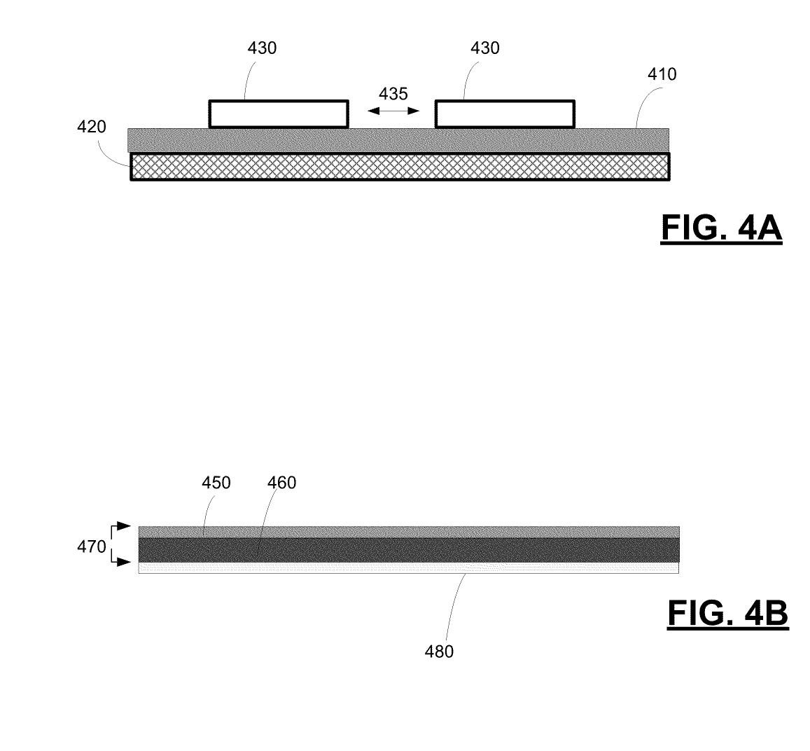

FIG. 4A illustrates an embodiment in which a layered quantity of doped semiconductor particles is combined with a layer of VSD material, according to another embodiment. The semiconductor layer 410 is comprised of N or P type doped semiconductor particles, such as silicon. A layer of VSD material 420 is positioned under the semiconductor layer 410. Conductive elements are positioned over the semiconductor layer 410, so that the semiconductor layer 410 separates the VSD material 420 from elements that comprise the conductive layer 430. FIG. 4A illustrates a horizontal switching arrangement, in which the electrodes that comprise the conductive layer 430 can switch across the gap 435 that is formed over the layers 410, 420. According to one or more embodiments, the semiconductive layer 410 is thin, as compared to the layer of VSD material 420. The presence of the semiconductive layer 410 enhances the non-linear electrical characteristics of the VSD material 420 by reducing lateral conduction within the thickness of the VSD material (thus promoting vertical conduction and switching). Examples of semiconductor particles for use with an embodiment of FIG. 4A include silicon, germanium, and compound semiconductors, such as gallium nitride, gallium arsenide, indium arsenide, and other compound semiconductors (e.g. of Type III-V).

As a variation to an embodiment of FIG. 4A, a resistive layer may be added to, or substituted for the semiconductor layer 410.

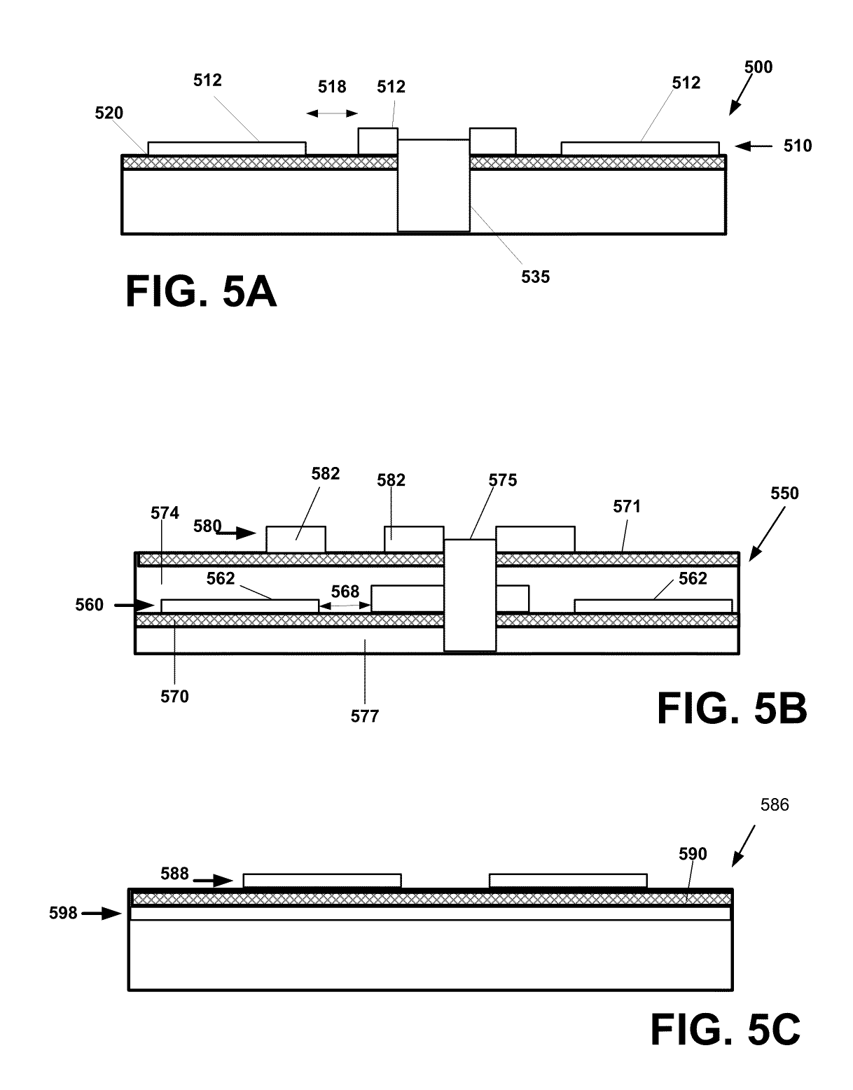

FIG. 4B illustrates an embodiment in which a P type and an N type semiconductor layer form a combined thickness with protective voltage switchable characteristics. More specifically, a P type and N type layer 450, 460 are composed of material, that when combined, conduct current only when sufficient voltage or field is present to overcome the electrical barrier formed by the junction of the two layers (‘PN layer 470’). The PN layer 470 may be formed from respective P and N type layers that are of different thickness. For example, as shown, the N type layer is thicker than the P type layer. The PN layer 470 is formulated to span a section of an underlying substrate 480, such as a majority of a circuit board or substrate coil. In some applications, the PN layer 470 is bounded to copper or other metal foils that form a substrate coil. Still further, the PN layer 470 may be applied in either horizontal or vertical switching arrangements, such as described with FIG. 5A through FIG. 5C.

VSD Material Applications

Numerous applications exist for compositions of VSD material in accordance with any of the embodiments described herein. In particular, embodiments provide for VSD material to be provided on substrate devices, such as printed circuit boards, semiconductor packages, discrete devices, thin film electronics, as well as more specific applications such as LEDs and radio-frequency devices (e.g. RFID tags). Still further, other applications may provide for use of VSD material such as described herein with a liquid crystal display, organic light emissive display, electrochromic display, electrophoretic display, or back plane driver for such devices. The purpose for including the VSD material may be to enhance handling of transient and overvoltage conditions, such as may arise with ESD events. Another application for VSD material includes metal deposition, as described in U.S. Pat. No. 6,797,125 to L. Kosowsky (which is hereby incorporated by reference in its entirety).

FIG. 5A illustrates a substrate device that is configured with VSD material having a composition such as described with any of the embodiments provided herein. As shown by FIG. 5A, the substrate device 500 corresponds to, for example, a printed circuit board. A conductive layer 510 comprising electrodes 512 and other trace elements or interconnects is formed on a thickness of surface of the substrate 500. In a configuration as shown, VSD material 520 (having a composition such as described with any of the embodiments described herein) may be provided on substrate 500 (e.g. as part of a core layer structure) in order provide, in presence of a suitable electrical event (e.g. ESD), a lateral switch between electrodes 512 that overlay the VSD layer 520. The gap 518 between the electrode 512 acts as a lateral or horizontal switch that is triggered ‘on’ when a sufficient transient electrical event takes place. In one application, one of the electrodes 512 is a ground element that extends to a ground plane or device. The grounding electrode 512 interconnects other conductive elements 512 that are separated by gap 518 to ground as a result of material in the VSD layer 520 being switched into the conductive state (as a result of the transient electrical event).

In one implementation, a via 535 extends from the grounding electrode 512 into the thickness of the substrate 500. The via provides electrical connectivity to complete the ground path that extends from the grounding electrode 512. The portion of the VSD layer that underlies the gap 518 bridges the conductive elements 512, so that the transient electrical event is grounded, thus protecting components and devices that are interconnected to conductive elements 512 that comprise the conductive layer 510.

FIG. 5B illustrates a configuration in which a conductive layer is embedded in a substrate. In a configuration shown, a conductive layer 560 comprising electrodes 562, 562 is distributed within a thickness of a substrate 550. A layer of VSD material 570 and dielectric material 574 (e.g. B-stage material) may overlay the embedded conductive layer. Additional layers of dielectric material 577 may also be included, such as directly underneath or in contact with the VSD layer 570. Surface electrodes 582, 582 comprise a conductive layer 580 provided on a surface of the substrate 550. The surface electrodes 582, 582 may also overlay a layer VSD material 571. One or more vias 575 may electrically interconnect electrodes/conductive elements of conductive layers 560, 580. The layers of VSD material 570, 571 are positioned so as to horizontally switch and bridge adjacent electrodes across a gap 568 of respective conductive layers 560, 580 when transient electrical events of sufficient magnitude reach the VSD material.

As an alternative or variation, FIG. 5C illustrates a vertical switching arrangement for incorporating VSD material into a substrate. A substrate 586 incorporates a layer of VSD material 590 that separates two layers of conductive material 588, 598. In one implementation, one of the conductive layers 598 is embedded. When a transient electrical event reaches the layer of VSD material 590, it switches conductive and bridges the conductive layers 588, 598. The vertical switching configuration may also be used to interconnect conductive elements to ground. For example, the embedded conductive layer 598 may provide a grounding plane.

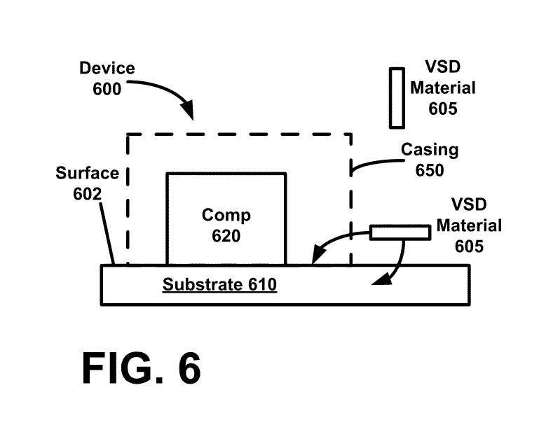

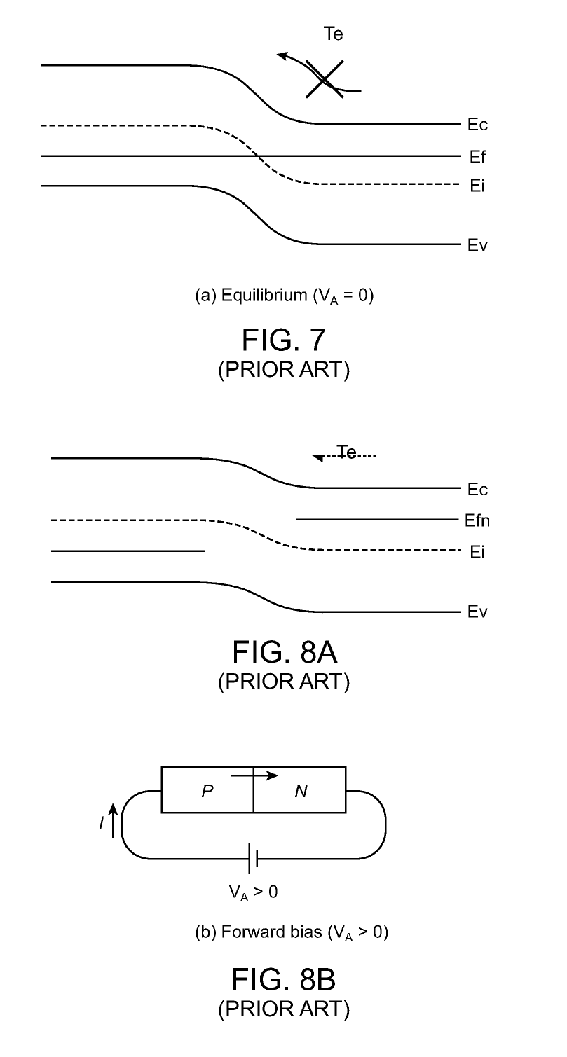

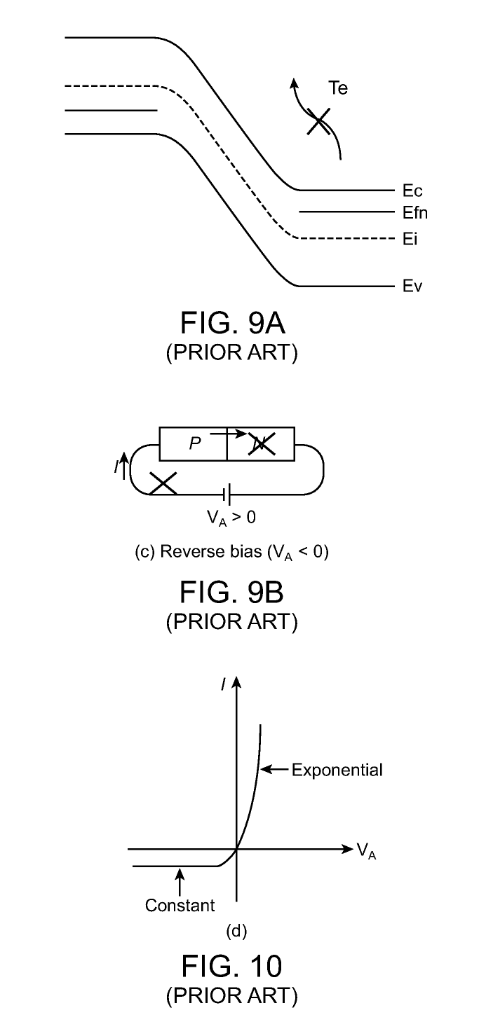

FIG. 6 is a simplified diagram of an electronic device on which VSD material in accordance with embodiments described herein may be provided. FIG. 6 illustrates a device 600 including substrate 610, component 620, and optionally casing or housing 650. VSD material 605 (in accordance with any of the embodiments described) may be incorporated into any one or more of many locations, including at a location on a surface 602, underneath the surface 602 (such as under its trace elements or under component 620), or within a thickness of substrate 610. Alternatively, the VSD material may be incorporated into the casing 650. In each case, the VSD material 605 may be incorporated so as to couple with conductive elements, such as trace leads, when voltage exceeding the characteristic voltage is present. Thus, the VSD material 605 is a conductive element in the presence of a specific voltage condition.

With respect to any of the applications described herein, device 600 may be a display device. For example, component 620 may correspond to an LED that illuminates from the substrate 610. The positioning and configuration of the VSD material 605 on substrate 610 may be selective to accommodate the electrical leads, terminals (i.e. input or outputs) and other conductive elements that are provided with, used by or incorporated into the light-emitting device. As an alternative, the VSD material may be incorporated between the positive and negative leads of the LED device, apart from a substrate. Still further, one or more embodiments provide for use of organic LEDs, in which case VSD material may be provided, for example, underneath an organic light-emitting diode (OLED).

With regard to LEDs and other light emitting devices, any of the embodiments described in U.S. patent application Ser. No. 11/562,289 (which is incorporated by reference herein) may be implemented with VSD material such as described with other embodiments of this application.

Alternatively, the device 600 may correspond to a wireless communication device, such as a radio-frequency identification device. With regard to wireless communication devices such as radio-frequency identification devices (RFID) and wireless communication components, VSD material may protect the component 620 from, for example, overcharge or ESD events. In such cases, component 620 may correspond to a chip or wireless communication component of the device. Alternatively, the use of VSD material 605 may protect other components from charge that may be caused by the component 620. For example, component 620 may correspond to a battery, and the VSD material 605 may be provided as a trace element on a surface of the substrate 610 to protect against voltage conditions that arise from a battery event. Any composition of VSD material in accordance with embodiments described herein may be implemented for use as VSD material for device and device configurations described in U.S. patent application Ser. No. 11/562,222 (incorporated by reference herein), which describes numerous implementations of wireless communication devices which incorporate VSD material.

As an alternative or variation, the component 620 may correspond to, for example, a discrete semiconductor device. The VSD material 605 may be integrated with the component, or positioned to electrically couple to the component in the presence of a voltage that switches the material on.

Still further, device 600 may correspond to a packaged device, or alternatively, a semiconductor package for receiving a substrate component. VSD material 605 may be combined with the casing 650 prior to substrate 610 or component 620 being included in the device.

Although illustrative embodiments have been described in detail herein with reference to the accompanying drawings, variations to specific embodiments and details are encompassed herein. It is intended that the scope of the invention is defined by the following claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A composition of voltage switchable dielectric (VSD) material comprising:
a binder; and
one or more types of particles dispersed in the binder, the one or more types of particles including a concentration of doped semiconductor particles.

2. The composition of claim 1, wherein the concentration of doped semiconductor particles is only one of P typed particles or N typed particles.

3. The concentration of claim 1, wherein the concentration of doped semiconductor particles comprises Silicon, Germanium, or a compound semiconductor.

4. The composition of claim 1, wherein the concentration of doped semiconductor particles includes a concentration of P type particles and a concentration of N type particles.

5. The composition of claim 1, wherein the concentration of N type particles is greater than the concentration of P type particles by at least 50%.

6. The composition of claim 1, wherein the concentration of P type particles and the concentration of N type particles are loaded into the binder past a percolation threshold of the composition.

7. The composition of claim 1, wherein the concentration of doped semiconductor particles are nano-dimensioned.

8. The composition of claim 1, wherein the binder has a P type or N type characteristic.

9. The composition of claim 8, wherein the binder includes N or P type semiconductor material that is organic or organometallic

10. A composition of voltage switchable dielectric (VSD) material comprising material that has a P type characteristic and material that has an N type characteristic.

11. The composition of claim 10, wherein the VSD material includes a binder that has one of the P type or N type characteristic.

12. The composition of claim 11, wherein the binder includes N or P type semiconductor material that is organic or organometallic.

13. The composition of claim 10, wherein the VSD material includes a binder that has an N type characteristic, and a concentration of particles that have a P type characteristic.

14. The composition of claim 10, wherein the VSD material includes a binder that has an P type characteristic, and a concentration of particles that have a N type characteristic.

15. The composition of claim 10, wherein the VSD material includes a binder that has one of the P type or N type characteristic, a first concentration of doped semiconductor particles that have a P type characteristic, and a second concentration of doped semiconductor particles that have a P type characteristic.

16. A substrate device comprising:
a pair of electrodes separated by a thickness of material that (i) includes voltage switchable dielectric (VSD) material, and (ii) a concentration of at least one of P type or N type material.

17. The substrate device of claim 16, wherein the concentration of at least one of P type or N type material is integrated and mixed to comprise a layer of the VSD material.

18. The substrate device of claim 16, wherein the pair of electrodes are positioned in a horizontal switching alignment.

19. The substrate device of claim 18, wherein the concentration of at least one of P type or N type material is provided as a first layer that separates a second layer of the VSD material from the pair of electrodes.

20. The substrate device of claim 16, wherein the pair of electrodes are positioned in a vertical switching alignment.

21. A substrate device comprising:
a thickness comprising a first layer of P type material, and a second layer of N type material, wherein the thickness, including the P type material and the N type material span a majority of the substrate device.

22. The substrate device of claim 21, wherein the thickness is bonded to a metal foil.
